(19) United States
(12) Patent Application Publication
(10) Pub. No.: US 2007/0174306 A1
(43) Pub. Date: Jul. 26, 2007

(54) Data extraction and conversion methods and apparatuses

(75) Inventors: Alexander G. Gibson, West Richland, WA (US); Nicholas O. Cramer, Kennewick, WA (US); Wendy E. Cowley, Richland, WA (US); Ryan T. Scott, West Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/330,792

(22) Filed: Jan. 11, 2006

(51) Int. Cl. G06F 7/00

(52) U.S. Cl. 707/100

(57) ABSTRACT

Data extraction and conversion processes and apparatuses are described according to some aspects. In one aspect, a data extraction and conversion process comprises applying at least one template to the information sources, analyzing the data from the information sources according to the templates, thereby generating parsed data values, and writing the parsed data values from the information sources into a common format. The templates comprise a plurality of parsing steps in a multi-path configuration. In another aspect, an apparatus comprises a computer-readable medium having a plurality of parsing step modules and configured to receive data from the information sources, an input device configured to select and arrange at least two parsing step modules as parsing steps in a multi-path configuration, thereby creating a template, and processing circuitry configured to generate parsed data values by analyzing data from the information sources according to the template. The processing circuitry also writes the parsed data values in a common format. Both the computer-readable medium and the input device are operably connected to the processing circuitry.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Using traditional data extraction tools, information workers must often spend significant time cleaning, sorting, and reformatting data in preparation for data analysis. Furthermore, the data can arrive in massive amounts from different information sources and in various formats. This can make formatting and structuring data for use with various applications extremely challenging. Still further, when the data formats of information sources change, it has been difficult for users to conveniently make modifications to the extraction tool. Rather, users have typically had to either reformat the information sources or rely on programmers to revise and/or update the extraction tool.

### DESCRIPTION OF DRAWINGS

Embodiments of the invention are described below with reference to the following accompanying drawings.

FIGS. 1(a) and (b) are exemplary illustrations of an embodiment of templates.

FIG. 2 is an exemplary illustration of an embodiment of a graph architecture.

FIG. 3 is a block diagram of an exemplary apparatus according to one embodiment of the present invention.

FIG. 4 is a screen display illustrating an exemplary visual interface depicting a template, a parsing step graph, and an information source.

FIG. 5 is a block diagram depicting an embodiment of an algorithm for traversing a template.

FIG. 6 is a block diagram depicting an embodiment of an algorithm for traversing a parsing step graph.

### DETAILED DESCRIPTION

One aspect of the present invention encompasses a computer-implemented process for extracting and converting data from one or more information sources into a common format. The process comprises applying at least one template to the information sources, analyzing the data from the information sources according to the templates, thereby generating parsed data values, and writing the parsed data values from the information sources into a common format. The templates comprise a plurality of parsing steps in a multi-path configuration. In one embodiment, the common format comprises a tagged structured data format. Examples of a tagged structured data format can include, but are not limited to XML, HTML, and SGML.

In one embodiment, the templates comprise fields having parsing steps arranged as nodes in a graph architecture. Furthermore, the nodes can be aligned in columns and rows. Examples of parsing steps can include, but are not limited to Patterns, Tagged Values, Splitter, Date Normalizer, MD5 Signature Generation, Substitution, Combine, Filter, Validate, Decisions, Extract, and Create. Some parsing steps can receive a plurality of parsing step values and can process the plurality of values as a collection, or set. Thus, embodiments of the present invention are not limited to a single data value flowing through a single list of steps.

The process can further comprise retaining metadata about the data being analyzed. The metadata can be logged and stored in storage circuitry. In one embodiment, the metadata is incoming parsing step values, outgoing parsing step values, or a combination thereof. By retaining the incoming and outgoing parsing step values, a record can be constructed of the events occurring at each parsing step. In another embodiment, the metadata can comprise a status value for each parsing step. The status value can indicate the condition of a parsing step and/or the data values related to that parsing step. Examples of status values can include, but are not limited to, successful execution, failed execution, and partial success. Partial success, as used herein, can refer to the situation in which all templates contain at least one error but the template having extracted the most elements (e.g., parsed data values) is retained.

In one embodiment, since portions of the template can have a multi-path configuration of parsing steps, the analysis of the data from the information sources according to the templates can occur recursively through each path. In other words, the parsing steps in a first path can be traversed first. The dependencies of each first traversed parsing step can be checked, and if one or more dependencies indicate a second path, the second path can subsequently be traversed. Thus, the multi-path configuration of parsing steps can be processed in a pseudo-serial fashion. Alternatively, the multiple paths can be traversed and processed substantially in parallel.

In another embodiment, the writing of parsed data values can comprise representing the parsed data values as indexes into the information sources. Accordingly, the indexed, parsed data values can be highlighted within the original information source. The actual information sources can include, but are not limited to the world wide web, email, news, reports, documents, and combinations thereof.

Another aspect of the present invention is an apparatus for extracting and converting data from one or more information sources into a common format. The apparatus comprises a computer-readable medium having a plurality of parsing step modules and configured to receive data from the information sources, an input device configured to select and arrange at least two parsing step modules as parsing steps in a multi-path configuration, thereby creating a template, and processing circuitry configured to generate parsed data values by analyzing data from the information sources according to the template. The processing circuitry also writes the parsed data values in a common format. Both the computer-readable medium and the input device are operably connected to the processing circuitry.

The apparatus can further comprise a visual interface on a display device that is operably connected to and/or controlled by the processing circuitry. The visual interface can depict a graph architecture of the parsing steps in the template. In one embodiment, the parsing steps are represented by nodes in the graph architecture. The nodes in the graph architecture can be aligned in columns and rows. The visual interface can further depict the information sources, wherein parsed values can be highlighted within the information sources.

For a clear and concise understanding of the specification and claims, including the scope given to such terms, the following definitions are provided.

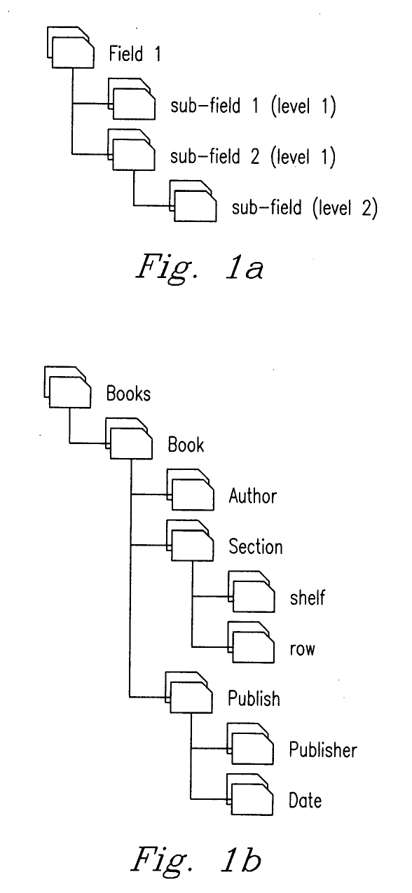

Template, as used herein, can refer to a hierarchy of fields that correspond to the desired structure of a common format. Each field in the template can have a plurality of parsing steps. Each parsing step can produce one or more parsing step values. The final parsing step value can be used as the parsed data value, which can be returned to populate the appropriate field in the template. Referring to FIGS. 1(a) and (b), illustrations of specific embodiments are provided to serve as examples of templates.

Parsing step modules, as used herein, can refer to computer-executable instructions for performing parsing steps. Accordingly, a parsing step refers to the implementation of a parsing step module, for example, in a template. The parsing steps define operations that are performed on data values, which can comprise portions of text from an information source. In one embodiment, parsing steps receive a plurality of data values and/or parsing step values as input and can produce one or more parsing step values as output. Examples of parsing steps are included below for illustrative purposes and are not intended to serve as limitations to the scope of the present invention. Thus, additional and/or modified parsing steps can exist and still fall within the scope of the present invention. For convenience, they are named according to function.
Extract: Extracts a portion of text from an information source. Extraction can be based on a predefined pattern, etc.
Create: Receives one or more functions and/or parameters, for example, from a user, and generates a new data value based on the inputted text and/or parsing step value. An example, for illustrative purposes, can include changing the string “US” to “United States.”
Date: Manipulates the format of a date. For example, the Date parsing step can receive a date data value having a mm:dd:yyyy format and create an output having a dd:mm:yy format.
Combine: Receives a plurality of data values and creates a new output. An example can include, but is not limited to, combining the first name “John” with the last name “Doe” to generate a name value of “John Doe.”
MD5 Signature Generation: Generates a MD5 cryptographic hash.
Filter: Filters out unwanted values based on user-specified conditions.
Validate: Performs similar function as Filter, but also alerts upon detection of unwanted values.
Decision: Analyzes value for user defined conditions and directs data values down different paths for processing by parsing steps further down the chain.

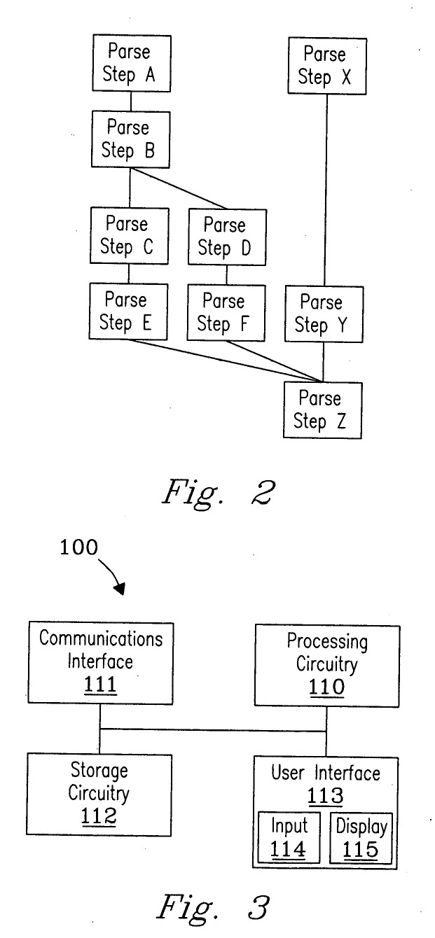

Graph architecture, as used herein, can refer to an architecture of parsing steps and their linkages that determines how values are extracted and converted from a document. An exemplary graph architecture is depicted in FIG. 2. The linkages can be non-serial and can contain multiple paths. Some embodiments can utilize more than one root node (e.g., more than one starting point for adding parsing steps). A contrasting example is a tree structure that is limited to only one root node from which child nodes can branch. Another contrasting example is a linear arrangement of parsing steps that is limited to serial arrangements and execution of the parsing steps. Details regarding data parsing using linear arrangements and serial execution of parsing steps are provided in U.S. patent application Ser. No. 10/714,541 (attorney docket 13938-E), which details are incorporated herein by reference.

FIG. 3 is a block diagram of an exemplary apparatus, according to one embodiment, for extracting and converting data from one or more information sources into a common format. In the depicted embodiment, the apparatus 100 is implemented as a computing device such as a server, work station, or personal computer, and may include a communications interface 111, processing circuitry 110, storage circuitry 112, and a user interface 113. Other embodiments may include more, less, and/or alternative components.

The communications interface 111 is configured to facilitate communications between apparatus 100 and a network, external device, etc. The communications interface can 111 be implemented as a network interface card (NIC), serial or parallel connection, USB port, Firewire port, flash memory interface, floppy disk drive, optical-media drive, or any other suitable arrangement for communicating with respect to apparatus 100.

In one embodiment, the communications interface 111 is configured to receive and access data from information sources for processing by the apparatus 100. For example, communications interface 111 can be operably connected to a source of data including information sources such as databases, the internet, email, news feeds, reports, and documents.

In one embodiment, the processing circuitry 110 can be configured to process data, control data access and storage, issue commands, control a graphical interface on a display device, and control other desired operations. The processing circuitry may operate to access data that are received by the communications interface 111, to create a template based on user input, and to generate parsed data values by analyzing the data according to the template.

The processing circuitry can comprise circuitry configured to implement desired programming provided by appropriate media in at least one embodiment. For example, the processing circuitry can be implemented as one or more of a processor and/or other structure configured to execute computer-executable instructions. Such instructions can include, but are not limited to software instructions, firmware instructions, and/or hardware circuitry. Exemplary embodiments of processing circuitry 110 include hardware logic, PGA, FPGA, SAIC, state machines, and/or other structures alone or in combination with a processor. The examples above are given for purposes of illustration and other configurations are possible.

The storage circuitry 112 is configured to store programming, electronic data, databases, and/or other digital information and may include processor-usable media. Programming, as used herein, can include executable code or instructions, for example software and/or firmware. An example of programming can include programming configured to cause apparatus 100 to generate, write, and display parsed data values extracted from various information sources. Processor-usable media includes any computer program product or article of manufacture that can contain, store, or maintain programming, data, and/or digital information for use by, or in connection with, an instruction execution system including the processing circuitry in the exemplary embodiment. For example, processor-usable media can include any of the physical media such as electronic, magnetic, optical, electromagnetic, infrared, or semiconductor media. Specific examples of processor-usable media can include, but are not limited to, portable magnetic computer diskettes (e.g., floppy disks), zip disks, hard drives, random access memory, read only memory, flash memory, cache memory, thumb drives, and compact discs.

At least some embodiments, or aspects described herein, may be implemented using programming stored within appropriate storage circuitry as described above and/or communicated via a network or other appropriate transmission medium and configured to control appropriate processing circuitry. For example, programming can be provided via appropriate media, for example, articles of manufacture embodied by a data signal (e.g., modulated carrier wave, data packets, digital representations, etc.) communicated via an appropriate transmission medium. Examples of a transmission medium can include, but are not limited to, a communication network, a wired electrical connection, an optical connection, and/or electromagnetic energy communicating via the communications interface 111, or provided using other appropriate communication structure or medium. Exemplary programming including processor-usable code may be communicated as a data signal embodied in a carrier wave in but one example.

The user interface 113 is configured to interact with a user by, for example, conveying data to the user and/or receiving inputs from the user. Data conveyance can include, but is not limited to, displaying data for observation by the user and audibly communicating data to the user. User input can include, but is not limited to, tactile input and voice instruction. In one illustrative embodiment, the user interface 113 comprises a visual display 115 configured to depict visual information and at least one input device 114. Examples of visual displays can include, but are not limited to, cathode ray tubes, liquid-crystal displays, and plasma displays. Examples of an input device can include, but are not limited to, a keyboard, mouse, and a pen and tablet combination.

The embodiment described above comprises an integrated unit configured to extract and convert data from one or more information sources into a common format. Other configurations are possible wherein apparatus 100 is configured, for example, as a networked server. The server can be configured to process information sources and generate parsed data in a common format. One or more clients comprising appropriately connected terminals can access the parsed data for display, analysis, and/or additional manipulation by one or more users. Other configurations of apparatus 100 are possible.

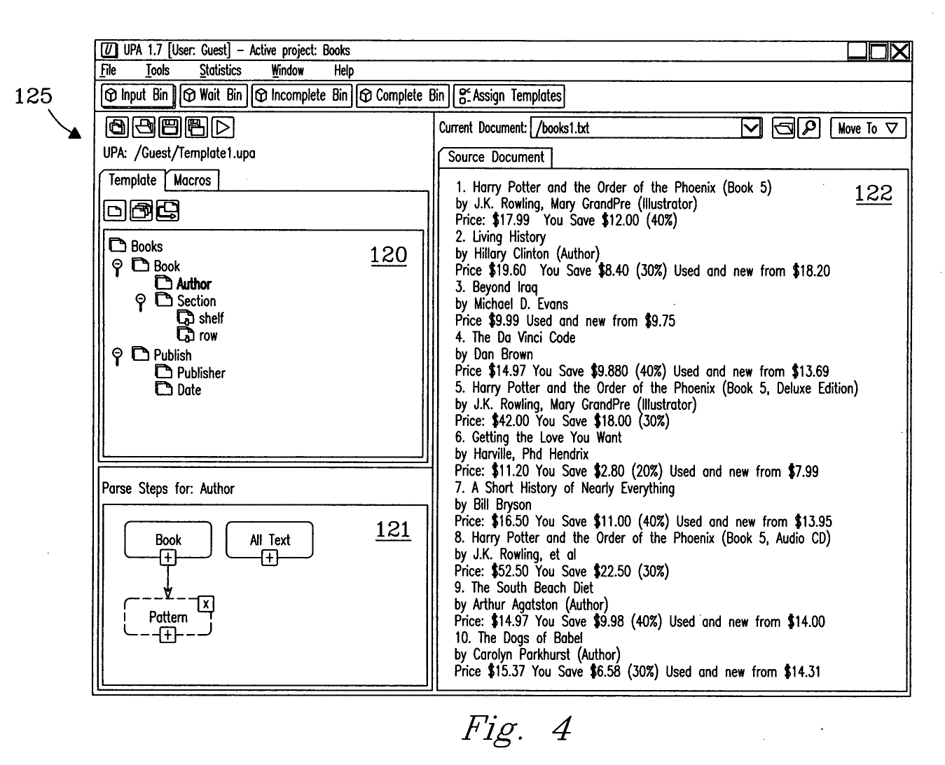

Referring to FIG. 4, an illustrative screen display 125 is shown depicting a template 120, parse steps 121, and a source document 122 (e.g., a book list). The screen display 125 shows one possible example of a user interface display for defining parameters and depicting results of processing data from an information source. Other arrangements for the user interface display are possible.

In the example presented in FIG. 4, the illustrated screen display 125 depicts the relationships between the template, the parse steps, and the source document as well as the results of the parsing process. The template comprises an arrangement of fields and sub-fields, which in the present example include “books,” “authors,” “section,” “shelf,” “row,” “publish,” “publisher,” and “date.” In the illustration, the author field has been selected, as indicated by the highlighting. Accordingly, the parsing steps 121 associated with the author field are shown in the lower left. The parsing steps are arranged in a graph architecture. The parsing steps define the manner in which data can be extracted and converted into a common format from the information source, which in this example, comprises book lists. The data that will be extracted and converted are highlighted in the source document 122 (e.g., the authors of books in the book list). Highlighting in the source document can be achieved by representing parsed data values as indexes into the source document.

Parsing steps can stem from multiple root nodes and can occur along multiple paths. Accordingly, some parsing steps can receive data values and/or parsing step values from a plurality of parent parsing steps. Similarly, some parsing steps can output parsing step values to a plurality of child parsing steps. In order to visually represent the parsing steps in a stable fashion, in one embodiment, the graph architecture can be column and row oriented. Stable, as used herein, can refer to a property of the graph architecture describing the ability of the architecture to maintain the overall appearance after parsing steps are added or removed.

Construction of a parsing step graph, according to one example of the present embodiment, can comprise trying to initially align parsing steps in one column. In the present example, all child steps occur in a row directly beneath, or further below, the parent. Therefore, when a child step is added to a parent, it should be added directly below the parent. Additional children (i.e., siblings) should be added to one side of the first child. Thus, siblings will typically occur in a single row. Grandchild steps can be added below child steps, and so on. A layout algorithm describing the above can be summarized as follows:
y>x
n=m+(number of children already positioned)
where x represents the row number of a parent step, y is the row number of a child to be added, m represents the column number of a parent, and n represents the column number of a child to be added. A step in the graph cannot be in the same column of a child to which it does not belong. If a child is added to a parent and is subsequently placed in the column of another, the parsing step directly above the relocated child moves over to another column since it is not in the lineage of the relocated child. If a child has two parents, then the child is treated as a child of the outermost parent and will be placed on a row that is below the lowest parent. The layout algorithm can be processed by processing circuitry 110 to control the display of the parsing steps on display device 115.

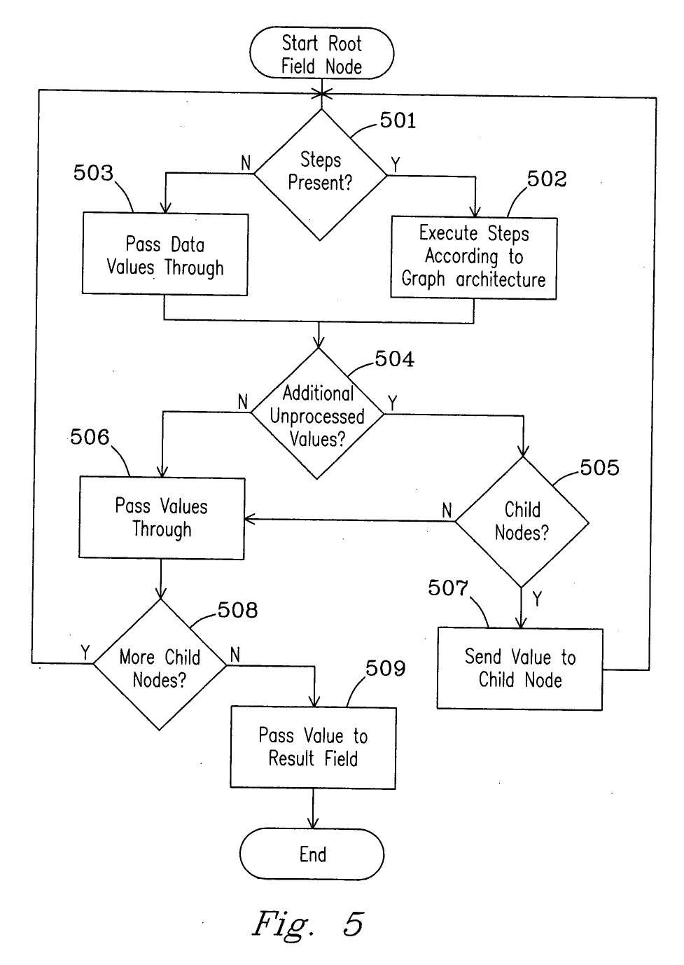

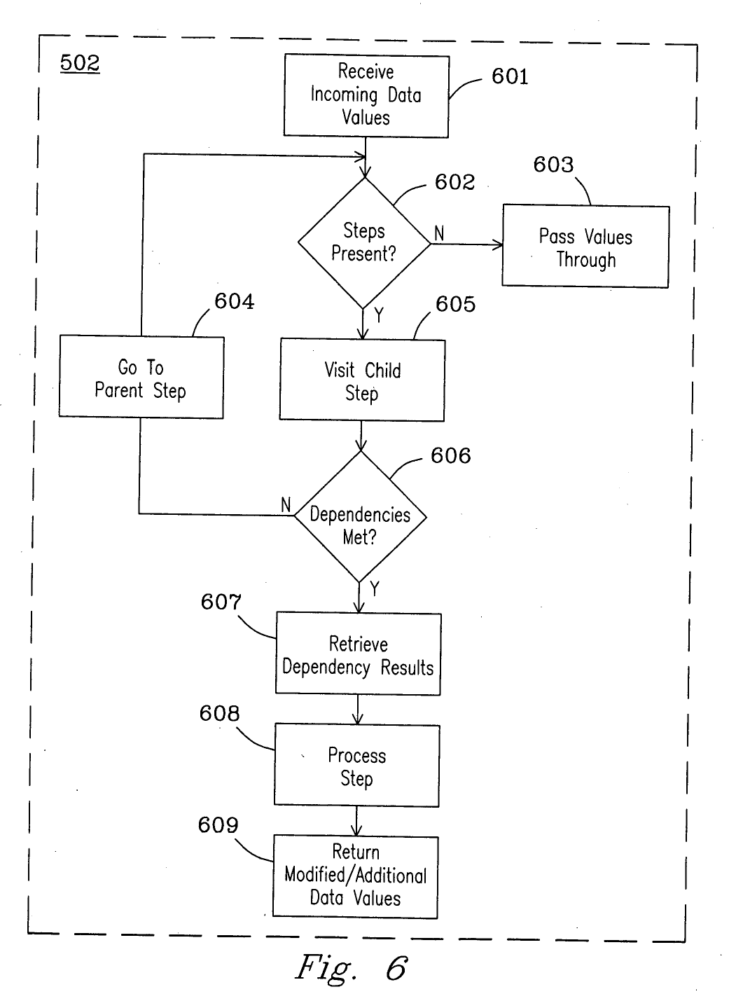

In one embodiment, processing circuitry 110 can traverse the template and parsing steps according to the exemplary algorithms depicted by the block diagrams in FIG. 5 and FIG. 6, which algorithms can be embodied by computer-readable instructions stored in storage circuitry 112.

Referring to FIG. 5, having been provided a template with parsing steps and at least one information source, apparatus 100 evaluates whether or not parsing steps are present 501 for a particular template field node. If there are no parsing steps, the data values can be passed through 503. If parsing steps are present, the parsing steps are executed 502 according to their graph architecture to generate parsing step values. An exemplary algorithm for Execution of the parsing steps is depicted by the block diagram in FIG. 6 and will be described below.

Apparatus 100 then checks for additional unprocessed data values and/or parsing step values 504. If none exist, then the data values from the previous steps are passed through 506. If additional unprocessed data values do exist and child field nodes are present 505, then the additional data values are sent to those child nodes and the process for those values returns to element 501. If no child field node exists 505, then the additional unprocessed data values are passed through 506.

If there are no other child nodes 508, then the data values and/or parsing step values are returned to the template field as the parsed data value 509. If more child field nodes do exist, then the data values and/or parsing step values are returned to element 501.

Referring to FIG. 6, an exemplary process is provided depicting one embodiment of an algorithm for executing parsing steps according to the graph architecture. The process depicted in FIG. 6 is represented summarily by element 502 in FIG. 5. Once data values are received 601 for a particular template field node, apparatus 100 checks for the presence of one or more parsing steps 602. If no parsing steps are present, then the data values are passed through 603. If parsing steps are present, the first of those steps are visited 605 and the data values are processed to produce parsing step values. Processing circuitry 110 then determines if all dependencies have been met 606. If not, then the algorithm returns to the parent parsing step 604 and to element 602. An example of a situation in which dependencies may not be met is when multiple paths of parsing steps exist and data values and/or parsing step values from each path combine into a single parsing step. In such a scenario, the combining parsing step must receive the data values and/or the parsing step values from each path before being able to properly calculate a new parsing step value. Once the dependencies have been met, the dependency results are retrieved 607 and the combining parsing step can be processed 608. The resulting parsing step values are then passed through 609.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented process for extracting and converting data from one or more information sources into a common format, comprising:
applying at least one template to the information sources, wherein the templates comprise a plurality of parsing steps in a multi-path configuration;
analyzing the data from the information sources according to the templates, thereby generating parsed data values; and
writing the parsed data values from the information sources into a common format.

2. The process as recited in claim 1, wherein the templates comprise parsing steps arranged as nodes in a graph architecture.

3. The process as recited in claim 2, wherein nodes in the graph architecture are aligned in columns and rows.

4. The process as recited in claim 1, wherein the parsing steps are selected from the group consisting of Patterns, Tagged Values, Splitter, Date Normalizer, MD5 Signature Generation, Substitution, Combiner, Filter, Validate, Decisions, Extract, Create, and combinations thereof.

5. The process as recited in claim 1, further comprising retaining metadata about the data being analyzed.

6. The process as recited in claim 5, wherein the metadata is incoming parsing step values, outgoing parsing step values, or a combination thereof.

7. The process as recited in claim 5, wherein the metadata comprises a status value for each parsing step.

8. The process as recited in claim 1, wherein said analyzing comprises performing the parsing steps in the multi-path configuration recursively.

9. The process as recited in claim 1, wherein said analyzing comprises performing the parsing steps in the multi-path configuration in parallel.

10. The process as recited in claim 1, wherein said analyzing comprises processing a plurality of parsing step values through a single parsing step.

11. The process as recited in claim 1, wherein said writing comprises representing the parsed data as indexes into the information sources.

12. The process as recited in claim 11, further comprising highlighting the indexed, parsed data in the information sources.

13. The process as recited in claim 1, wherein the information sources are selected from the group consisting of the world wide web, email, news, reports, documents, and combinations thereof.

14. An apparatus for extracting and converting data from one or more information sources into a common format, comprising:
a computer-readable medium having a plurality of parsing step modules and configured to receive data from the information sources;
an input device configured to select and arrange at least two parsing step modules as parsing steps in a multi-path configuration, thereby creating a template; and
processing circuitry configured to generate parsed data values by analyzing data from the information sources according to the template, and to write the parsed data values in a common format, wherein the processing circuitry is operably connected to the computer-readable medium and the input device.

15. The apparatus as recited in claim 14, further comprising a visual interface on a display device, the visual interface depicting a graph architecture of the parsing steps in the template.

16. The apparatus as recited in claim 15, wherein parsing steps are represented by nodes and nodes in the graph architecture are aligned in columns and rows.

17. The apparatus as recited in claim 15, wherein the visual interface further depicts the information sources and highlights parsed values within said information sources.

18. The apparatus as recited in claim 14, wherein the parsing steps modules are selected from the group consisting of Patterns, Tagged Values, Splitter, Date Normalizer, MD5 Signature Generation, Substitution, Combiner, Filter, Validate, Decisions, Extract, Create, and combinations thereof.

19. The apparatus as recited in claim 14, wherein the information sources are selected from the group consisting of the world wide web, email, news, reports, documents, and combinations thereof.

20. The apparatus as recited in claim 14, wherein the common format comprises a tagged structured data format.

21. The apparatus as recited in claim 20, wherein the tagged structured data format is XML, HTML, SGML, or a combination thereof.
